(19) United States
(12) Patent Application Publication
(10) Pub. No.: US 2015/0062298 A1
(43) Pub. Date: Mar. 5, 2015

(54) IMAGE QUALITY INCREASING APPARATUS AND METHOD

(71) Applicants: Electronics and Telecommunications Research Institute, Daejeon (KR); Hidea Solutions Co., Ltd., Seoul (KR); Kookmin University Industry Academy Cooperation Foundation, Seoul (KR)

(72) Inventors: Hyon Gon CHOO, Daejeon (KR); Sung Hoon KIM, Daejeon (KR); Joo Young LEE, Daejeon (KR); Jin Soo CHOI, Daejeon (KR); Jin Woong KIM, Daejeon (KR); Jin Suk KWAK, Daejeon (KR); Dong Wook KANG, Seoul (KR); Kyeong Hoon JUNG, Seoul (KR); Suk Jin HONG, Seoul (KR)

(21) Appl. No.: 14/467,265

(22) Filed: Aug. 25, 2014

(30) Foreign Application Priority Data
Sep. 4, 2013 (KR) 10-2013-0106315

(51) Int. Cl. H04N 13/00

(52) U.S. Cl. CPC H04N 13/0018; H04N 13/004
USPC 348/43

(57) ABSTRACT

An image quality increasing apparatus for a binocular three-dimensional television (3DTV) is disclosed. The image quality increasing apparatus may include an error detection unit to detect whether a reference image includes an error, a reference information correction unit to correct reference information for increasing an image quality of an additional image based on a detection result, an image quality increasing unit to increase the image quality of the additional image corresponding to the reference information, and a three-dimensional (3D) image synthesis unit to synthesize a 3D image using the quality increased additional image and the reference image.

### CROSS-REFERENCE TO RELATED APPLICATION

This application claims the benefit of Korean Patent Application No. 10-2013-0106315, filed on Sep. 4, 2013, in the Korean Intellectual Property Office, the disclosure of which is incorporated herein by reference.

### BACKGROUND

1. Field of the Invention

The present invention relates to an image quality increasing apparatus and method, and more particularly, to an image quality increasing apparatus and method for increasing an image quality in an asymmetric hybrid binocular three-dimensional television (3DTV) receiver having different resolutions.

2. Description of the Related Art

With an increase in interest in three-dimensional (3D), demands for a 3D technology related to 3D movies and 3D broadcasting are maximized. In case of the 3D broadcasting, the 3D technology is requested to satisfy compatibility with an existing broadcasting environment and efficient use of channels. Therefore, the 3D technology uses a dual stream method that provides 3D broadcasting using a stream compatible with the existing broadcasting and other two streams compressed by a high compression encoding method. Recently, a hybrid method that uses streams compressed by the high compression encoding method in different transmission methods is rising. Here, the hybrid method includes mobile broadcasting, hybrid broadcasting, and the like.

In case of the hybrid method for the mobile broadcasting, additional images reduced to suit to the mobile broadcasting are used. For a 3D broadcasting service, the reduced images are enlarged to provide a binocular 3D broadcasting service. However, the hybrid method may not be able to provide accurate images when an image quality of the additional images is extremely low. When an error is generated in a reference image, a frame including the error is combined as it is with the additional images. Therefore, an accurate image quality may not be provided.

Accordingly, there is a desire for a method for preventing spread of errors in consideration of an error in a reference image and thereby increasing an image quality.

### SUMMARY

An aspect of the present invention provides an image quality increasing apparatus that prevents spread of an error and provides a three-dimensional (3D) service of an increased image quality, by determining whether the error is generated in a reference image and enabling selective processing based on the determination result, when increasing the image quality using reference information in an asymmetric 3D television (3DTV) such as a mobile hybrid 3DTV broadcasting receiver.

According to an aspect of the present invention, there is provided an image quality increasing apparatus including an error detection unit to detect whether a reference image includes an error, a reference information correction unit to correct reference information for increasing an image quality of an additional image based on a detection result, an image quality increasing unit to increase the image quality of the additional image corresponding to the reference information, and a three-dimensional (3D) image synthesis unit to synthesize a 3D image using the quality increased additional image and the reference image.

According to another aspect of the present invention, there is provided an image quality increasing apparatus including a reference image detection unit to detect whether a reference image includes an error, an additional image detection unit to detect whether an additional image includes an error, a reference information correction unit to correct reference information for increasing an image quality of the reference image and the additional image based on a detection result with respect to the reference image and a detection result with respect to the additional image, an image quality increasing unit to increase the image quality of the reference image and the additional image corresponding to the reference information, and a 3D image synthesis unit to synthesize a 3D image using the additional image and the reference image which are increased in the image quality.

According to another aspect of the present invention, there is provided an image quality increasing apparatus including an error detection unit to detect whether a first view image includes an error, an image synthesis unit to synthesize with a second view image having a different view from the first view image by controlling a weight value of reference information of an image in which the error is generated at the first view image according to a detection result, an image quality increasing unit to increase an image quality of the image based on a synthesis result, and a 3D image synthesis unit to synthesize a 3D image using the first view image and the second view image which are increased in the image quality.

According to another aspect of the present invention, there is provided an image quality increasing method including detecting whether a reference image includes an error, correcting reference information for increasing an image quality of an additional image based on a detection result, increasing the image quality of the additional image corresponding to the reference information, and synthesizing a 3D image using the quality increased additional image and the reference image.

According to another aspect of the present invention, there is provided an image quality increasing method including detecting whether a reference image includes an error, detecting whether an additional image includes an error, correcting reference information for increasing an image quality of the reference image and the additional image based on a detection result with respect to the reference image and a detection result with respect to the additional image, increasing the image quality of the reference image and the additional image corresponding to the reference information, and synthesizing a 3D image using the additional image and the reference image which are increased in the image quality.

According to another aspect of the present invention, there is provided an image quality increasing method including detecting whether a first view image includes an error, controlling a weight value an image in which the error is generated at the first view image based on a detection result, increasing an image quality of the image by synthesizing ith a second view image having a different view from the first view image according to a control result, and synthesizing a 3D image using the first view image and the second view image which are increased in the image quality.

### EFFECT

According to embodiments of the present invention, an image quality increasing apparatus that prevents spread of an error and provides a three-dimensional (3D) service of an increased image quality, by determining whether the error is generated in a reference image and enabling selective processing based on the determination result, when increasing the image quality using reference information in an asymmetric 3D television (3DTV) such as a mobile hybrid 3DTV broadcasting receiver.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an image quality increasing apparatus according to an embodiment of the present invention;

FIG. 2 is a diagram illustrating a configuration of an image quality increasing apparatus, according to an embodiment of the present invention;

FIG. 3 is a diagram illustrating an operational flow of an image quality increasing apparatus, according to an embodiment of the present invention;

FIG. 4 is a diagram illustrating a configuration of an image quality increasing apparatus, according to another embodiment of the present invention;

FIG. 5 is a diagram illustrating an operational flow of an image quality increasing apparatus, according to another embodiment of the present invention;

FIG. 6 is a diagram illustrating a configuration of an image quality increasing apparatus, according to still another embodiment of the present invention;

FIG. 7 is a flowchart illustrating an image quality increasing method according to an embodiment of the present invention;

FIG. 8 is a flowchart illustrating an image quality increasing method according to another embodiment of the present invention; and

FIG. 9 is a flowchart illustrating an image quality increasing method according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

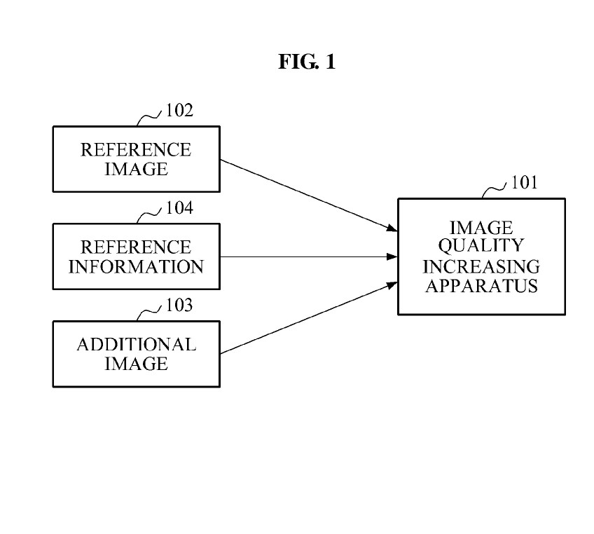

FIG. 1 is a diagram illustrating an image quality increasing apparatus 101 according to an embodiment of the present invention.

Referring to FIG. 1, the image quality increasing apparatus 101 may increase an image quality of an asymmetric three-dimensional television (3DTV) using reference information 104 depending on whether an error is generated in a reference image 102 in the asymmetric 3DTV. The asymmetric 3DTV may refer to a mobile hybrid 3DTV. The reference information 104 may include information indicating relationships between the reference image 102 and an additional image 103. For example, the reference information 104 may include a depth map, a disparity map, a conditional depth map, an interview vector, quality increasing reference information, and the like.

Since the image quality increasing apparatus 101 increases the image quality of the 3DTV depending on generation of the error in the reference image 102, spread of an error that may occur during image quality increasing may be prevented using the reference information 104 and, accordingly, the image quality of the 3DTV may be maintained. That is, when the image quality increasing apparatus 101 corrects a value of the additional image 103 using the reference information 104 without considering the error of the reference image 102, the error generated in the reference image 102 may spread to the additional image 103 through the correction. Therefore, the image quality increasing apparatus 101 may increase the image quality of the 3DTV by considering the error of the reference image 102 to prevent the error of the reference image 102 from spreading to the additional image 103.

Thus, the image quality increasing apparatus 101 may prevent spread of an error and provide a 3D service with a higher image quality, by detecting generation of the error in the reference image 102 and enabling selective processing of the error.

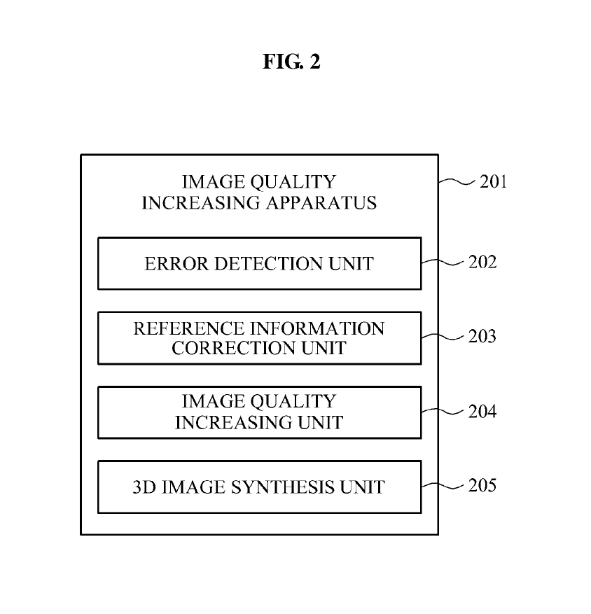

FIG. 2 is a diagram illustrating a configuration of an image quality increasing apparatus 201, according to an embodiment of the present invention.

Referring to FIG. 2, the image quality increasing apparatus 201 includes an error detection unit 202, a reference information correction unit 203, an image quality increasing unit 204, and a 3D image synthesis unit 205. The image quality increasing apparatus 201 may increase an image quality by correcting a value of an additional image using reference information depending on whether an error is generated in a reference image before a 3D image is synthesized. Here, the image quality increasing apparatus 201 may replace or correct the value of the additional image by referencing a value of the reference image.

The error detection unit 202 may detect whether the reference image includes the error. For example, the error detection unit 202 may detect presence of the error by extracting a block and a frame in which a transmission error is generated from the reference image received in units of block or frame. The reference image may be a high resolution image for synthesis of the 3D image. For example, the reference image may be a left image of a level of moving picture expert group (MPEG)-2 high definition (HD), having the high resolution.

For example, the error detection unit 202 may identify the transmission error during receiving with respect to the reference image having the high resolution for synthesis of the 3D image and the addition image having low resolution. That is, when the reference image is the left image of the level of MPEG-2 HD and the additional image is a right image of a standard definition (SD) based on H.264, the error detection unit 202 may detect the error by detecting the block and the frame in which the error is generated in units of the block or frame.

The error detection unit 202 may use different references in detection, according to the block unit or the frame unit by which the reference image is received.

When the reference image is received in units of the frame, the error detection unit 202 may determine presence of the error in units of the frame, by detecting the error depending on whether a loss is generated in data in units of the frame separated by demultiplexing (DEMUX). When detecting the error in units of the block or a part of the frame, when the reference image is received in units of the block, the error detection unit 202 may determine presence of the error in units of the block through a loss of stream data or by inspecting decoded data in units of the block. Here, the error detection unit 202 may check continuity of a decoded image with respect to a previous frame and peripheral blocks in units of macro block. When a continuous value is absent, the error detection unit 202 determines that a corresponding block may be an error block by a high probability.

Here, a result of detection about the error of the reference image may be stored in units of the frame or the block in a memory.

The reference information correction unit 203 may correct the reference information for increasing an image quality of the additional image based on the detection result. That is, the reference information correction unit 203 may correct the reference information or a weight value of the reference information, according to the detection result related to the error detected in units of the block or the frame with respect to the reference image. Here, the reference information correction unit 203 may determine the weight value of the reference information based on the detection result. For example, with respect to the block including the error, the reference information correction unit 203 may correct the weight value of the reference image included in the reference information to approximate to ‘0.’ Conversely, with respect to the block not including the error, the reference information correction unit 203 may correct the weight value of the reference image included in the reference information to approximate to ‘1.’

The image quality increasing unit 204 may increase the image quality of the additional image based on the reference information of which the weight value is corrected according to the detection result. That is, the image quality increasing unit 204 may increase the image quality of the additional image, by preventing the error included in the reference image from spreading to the additional image by correcting the reference information which is capable of increasing the image quality of the additional image based on the detection result with respect to the error of the reference image.

The 3D image synthesis unit 205 may synthesize the 3D image using the quality increased additional image and the reference image. When an error is generated in a current frame or in part of frames of the reference image, the 3D image synthesis unit may reconstruct the 3D image using only pixel information of the additional image without the reference image with respect to the error frame.

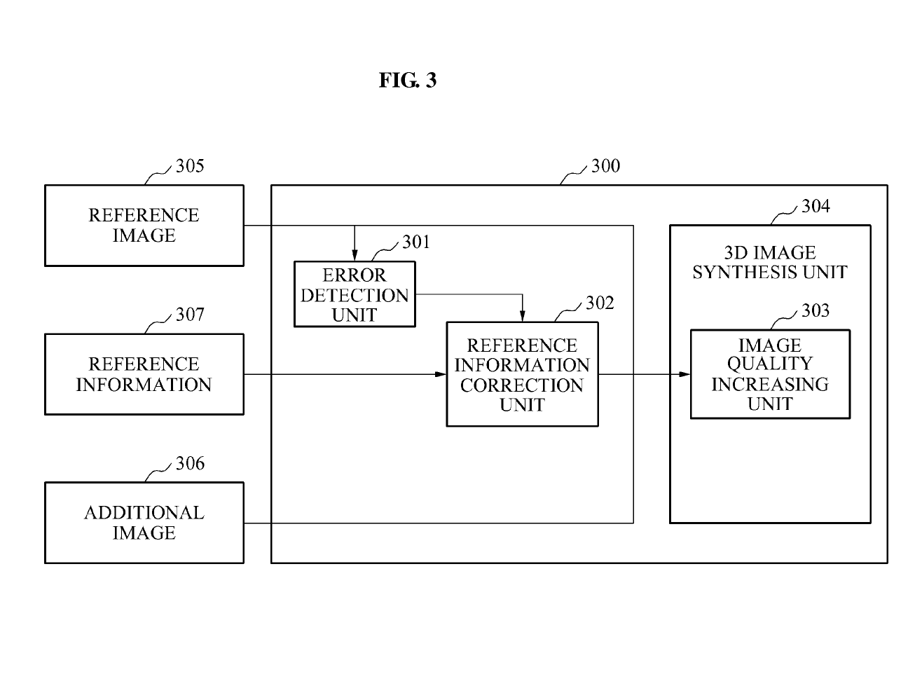

FIG. 3 is a diagram illustrating an operational flow of an image quality increasing apparatus 300, according to an embodiment of the present invention.

A configuration illustrated in FIG. 3 may be a combination of the image quality increasing apparatus 300 and a hybrid binocular 3DTV. A reference image 305, an additional image 306, and reference information 307 may be in a decoded state. For example, the reference image 305 may be a high resolution image of a level of MPEG-2 HD, that is an image decoded by an MPEG-2 video decoding unit. The additional image 306 may be a low resolution image which is decoded by a high resolution video decoding unit.

The image quality increasing apparatus 300 may include an error detection unit 301, a reference information correction unit 302, an image quality increasing unit 303, and a 3D image synthesis unit 304.

The error detection unit 301 may detect an error in the reference image 305 with respect to a result of video decoding of the hybrid binocular 3DTV. The error detection unit 301 may detect the error of the reference image 305 generated during decoding performed by the MPEG-2 video decoding unit. The error detection may be performed by inspecting a compression stream or a decoding result. In addition, the error detection unit 301 may detect the error in units of the frame or the block, and store the detected error in units of the frame or the block. The frame unit or the block unit may be stored in a binary type representing presence and absence of the error by ‘0’ and ‘1’ or stored as an error generation probability.

The reference information correction unit 302 may control the reference information or the weight value of the reference information, using the result of detection by the error detection unit 301 related to presence and absence of the error in the reference image 305. Here, the weight value of the reference information will be described with reference to Equation 1.

I′=αIᵤₚ+βI_{recon}_{_{—}}_{from}_{_{—}}_{ref} [Equation 1]

Equation 1 may be used for correcting the reference information or the weight value of the reference information for increasing an image quality of the additional image 306 based on the block unit or the frame unit in which the error is generated with respect to the reference image 305.

In Equation 1, Iup denotes an enlarged image of the additional image 306 having the low resolution and Irecon_from_ref refers to an image generated from the reference image using the reference information. The reference information for increasing the image quality of the additional image 306 may be indicated by linear combination of Iup and Irecon_from_ref.

When a sum of weight values α and β is 1, the reference information correction unit 302 may correct the weight value β of the reference image 305 to approximate to ‘0’ with respect to the block including the error, and correct the weight value β of the reference image 305 to approximate to ‘1’ with respect to the block not including the error.

When the error is generated in units of the frame, the reference information correction unit 302 may control the weight value β related to the reference information with respect to all blocks corresponding to the frame including the error. In addition, when the error is generated in units of the block, the reference information correction unit 302 may control the weight value β related to the reference information with respect to only the block including the error. Here, when only 0 and 1 are used as the weight value, the reference information correction unit 302 may operate in a same manner as controlling the weight value by correcting the reference information in a skip mode and the like.

The image quality increasing unit 303 may increase the image quality of the additional image based on the reference information of which the weight value is corrected according to the detection result. The 3D image synthesis unit 304 may synthesize the 3D image using the quality increased additional value and the reference image.

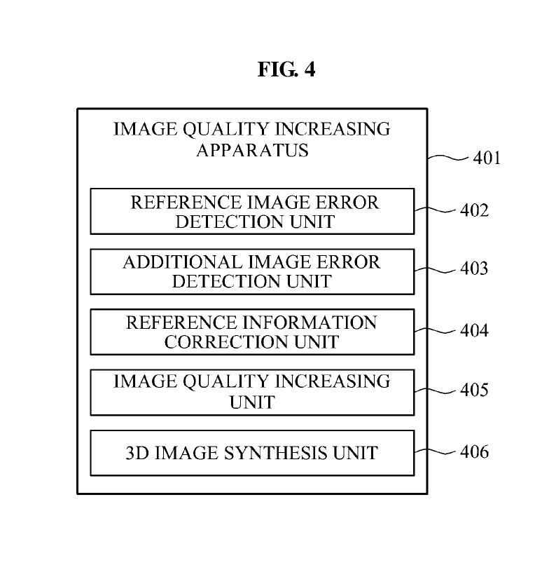

FIG. 4 is a diagram illustrating a configuration of an image quality increasing apparatus 401, according to another embodiment of the present invention.

Referring to FIG. 4, the image quality increasing apparatus 401 may detect errors of a reference image and an additional image and increase an image quality of the reference image and the additional image based on the errors. The image quality increasing apparatus 401 may include the reference image error detection unit 402, an additional image error detection unit 403, a reference information correction unit 404, an image quality increasing unit 405, and a 3D image synthesis unit 406.

The reference image error detection unit 402 may detect whether the reference image includes an error. The additional image error detection unit 403 may detect whether the additional image includes an error. The reference image error detection unit 402 and the additional image error detection unit 403 may detect presence of the error by extracting a block and a frame in which a transmission error is generated from the reference image received in units of block or frame.

The reference information correction unit 404 may correct reference information for increasing the image quality based on the detection result with respect to the reference image and the detection result with respect to the additional image. The reference information correction unit 404 may control the weight value 13 of Equation 1 based on the detection result of the reference image error detection unit 402 with respect to the reference image. The reference information correction unit 404 may control the weight value α of Equation 1 based on the detection result of the additional image error detection unit 403 with respect to the additional image.

The image quality increasing unit 405 may increase the image quality of the additional image based on the reference information of which the weight value is corrected according to the detection result. The 3D image synthesis unit 406 may synthesize a 3D image using the quality increased additional image and the reference image.

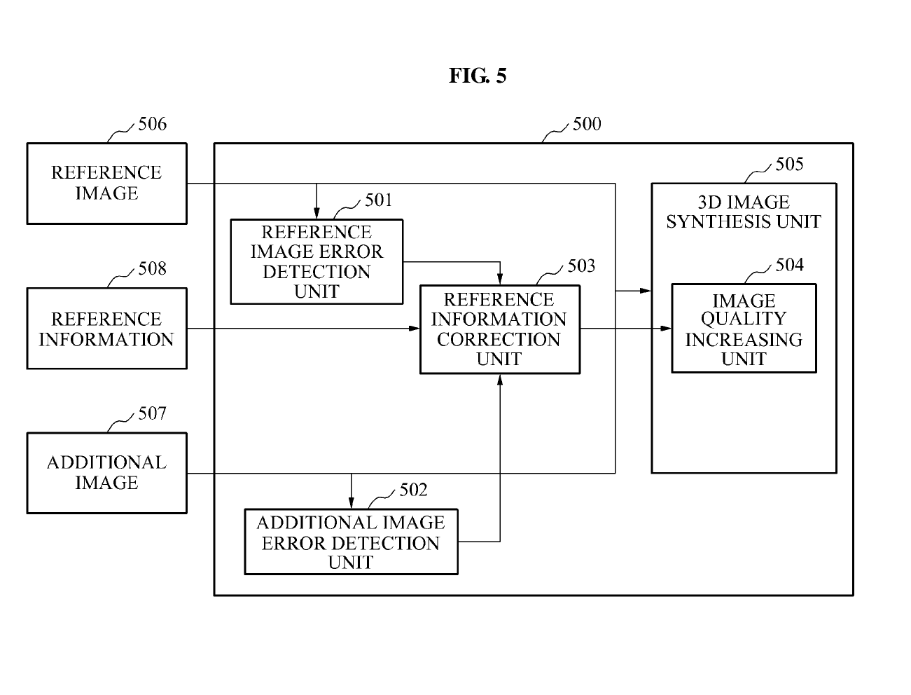

FIG. 5 is a diagram illustrating an operational flow of an image quality increasing apparatus 500, according to another embodiment of the present invention.

A configuration illustrated in FIG. 5 may relate to the image quality increasing apparatus expanded from the configuration of FIG. 3. A reference image 506, an additional image 507, and reference information 508 may be in a decoded state. For example, the reference image 506 may be a high resolution image of a level of MPEG-2 HD, that is an image decoded by an MPEG-2 video decoding unit. The additional image 507 may be a low resolution image which is decoded by a high resolution video decoding unit.

The image quality increasing apparatus 500 may include a reference image error detection unit 501, and an additional image error detection unit 502, a reference information correction unit 503, an image quality increasing unit 504, and a 3D image synthesis unit 505.

The reference image error detection unit 501 may detect whether the reference image 506 includes an error. The additional image error detection unit 502 may detect whether the additional image 507 includes an error. The reference information correction unit 503 may minimize the error of the reference image and the additional image by controlling a weight value of the reference image with respect to the error detected from the reference image and the additional image.

The image quality increasing unit 504 may increase an image quality of the additional image based on the reference information of which the weight value is corrected according to the detection result. The 3D image synthesis unit 505 may synthesize a 3D image using the quality increased additional image and the reference image.

Here, the error detection unit and the reference information correction unit illustrated in FIGS. 3 and 5 may be implemented in combination with a 3DTV or included in a 3DTV as a functional element. For example, the error detection unit may be implemented in combination with a decoder of the 3DTV whereas the reference information correction unit may be implemented in an additional image quality increasing unit of the 3DTV.

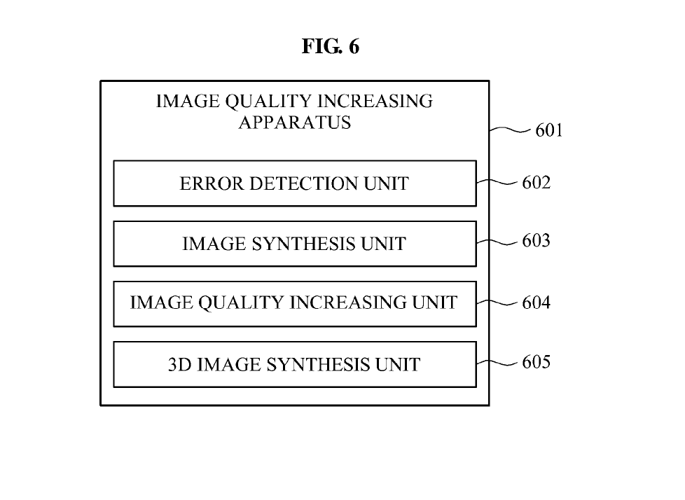

FIG. 6 is a diagram illustrating a configuration of an image quality increasing apparatus 601, according to still another embodiment of the present invention.

Referring to FIG. 6, the image quality increasing apparatus 601 may be applied to a multi view 3DTV capable of transmitting reference information. The image quality increasing apparatus 601 may be applied to various types of 3DTV, not limited to a hybrid binocular 3DTV or the multi view 3DTV. The image quality increasing apparatus 610 applied to the multi view 3DTV may increase an image quality by controlling and applying a weight value of an image in which an error is generated during synthesis with a second view image having a different view from a first view image, using a result of detection related to whether an error is generated in the first view image out of all view images.

The image quality increasing apparatus 601 may include an error detection unit 602, an image synthesis unit 603, an image quality increasing unit 604, and a 3D image synthesis unit 605.

The error detection unit 602 may detect whether the first view image includes the error. The first view image may have a random view among views provided by the multi view 3DTv.

The image synthesis unit 603 may synthesize with a second view image having a different view from the first view image, by controlling a weight value of reference information of an image in which the error is generated at the first view image according to the detection result.

The image quality increasing unit 604 may increase the image quality of the image based on a result of the synthesis. The 3D image synthesis unit 605 may synthesize a 3D image using the quality increased first view image and the second view image.

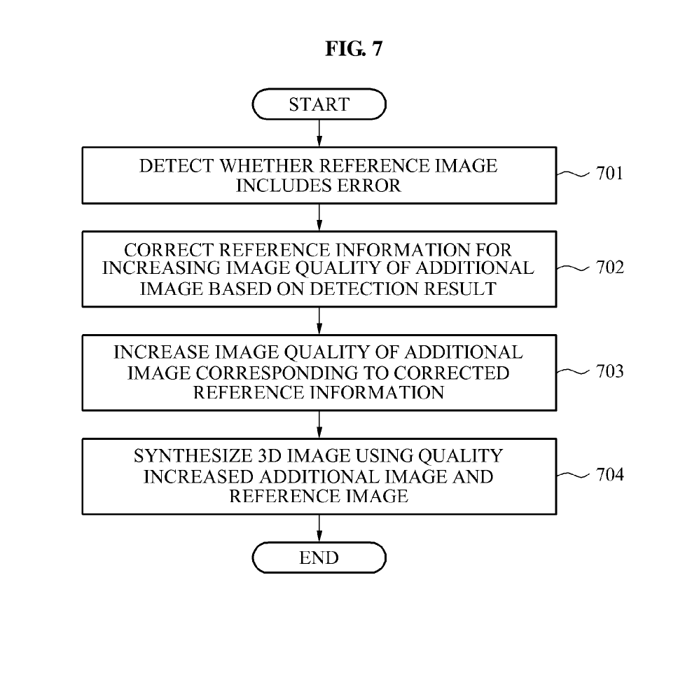

FIG. 7 is a flowchart illustrating an image quality increasing method according to an embodiment of the present invention.

In operation 701, an image quality increasing apparatus may detect whether a reference image includes an error, by extracting a block or a frame in which a transmission error is generated from the reference image received in units of block or frame. When the reference image is received in units of the frame, the image quality increasing apparatus may determine presence of the error in units of the frame, by detecting the error depending on whether a loss is generated in data in units of the frame separated by demultiplexing (DEMUX). When detecting the error in units of the block or a part of the frame, when the reference image is received in units of the block, the image quality increasing apparatus may determine presence of the error in units of the block through a loss of stream data or by inspecting decoded data in units of the block.

In operation 702, the image quality increasing apparatus may correct reference information or a weight value of the reference information in different manners depending on a result of the error detection performed in units of the block or frame with respect to the reference image. That is, with respect to the block including the error, the image quality increasing apparatus may correct the weight value of the reference image included in the reference information to approximate to ‘0.’ Conversely, with respect to the block not including the error, the image quality increasing apparatus may correct the weight value of the reference image included in the reference information to approximate to ‘1.’

In operation 703, the image quality increasing apparatus may increase the image quality of the additional image, by preventing the error included in the reference image from spreading to the additional image by correcting the reference information which is capable of increasing the image quality of the additional image based on the detection result with respect to the error of the reference image.

In operation 704, the image quality increasing apparatus may synthesize a 3D image using the quality increased additional image and the reference image.

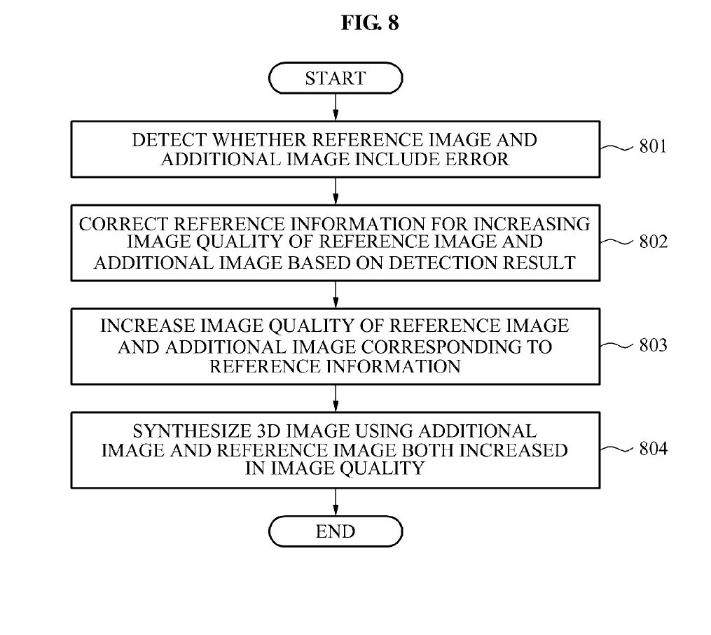

FIG. 8 is a flowchart illustrating an image quality increasing method according to another embodiment of the present invention.

In operation 801, an image quality increasing apparatus may detect whether an error is included in a reference image and in an additional image. Here, the image quality increasing apparatus may detect presence of the error by extracting a block or a frame in which a transmission error is generated from the reference image received in units of block or frame.

In operation 802, the image quality increasing apparatus may correct reference information for increasing the image quality of the image based on the detection result with respect to the reference image and the detection result with respect to the additional image. In detail, the image quality increasing apparatus may control a weight value of the reference image included in the reference information based on the detection result with respect to the reference image. In addition, the image quality increasing apparatus may control a weight value of the additional image included in the reference information based on the detection result with respect to the additional image.

In operation 803, the image quality increasing apparatus may increase the image quality of the additional image based on the reference information of which the weight value is corrected according to the detection result.

In operation 804, the image quality increasing apparatus may synthesize a 3D image using the quality increased additional image and the reference image.

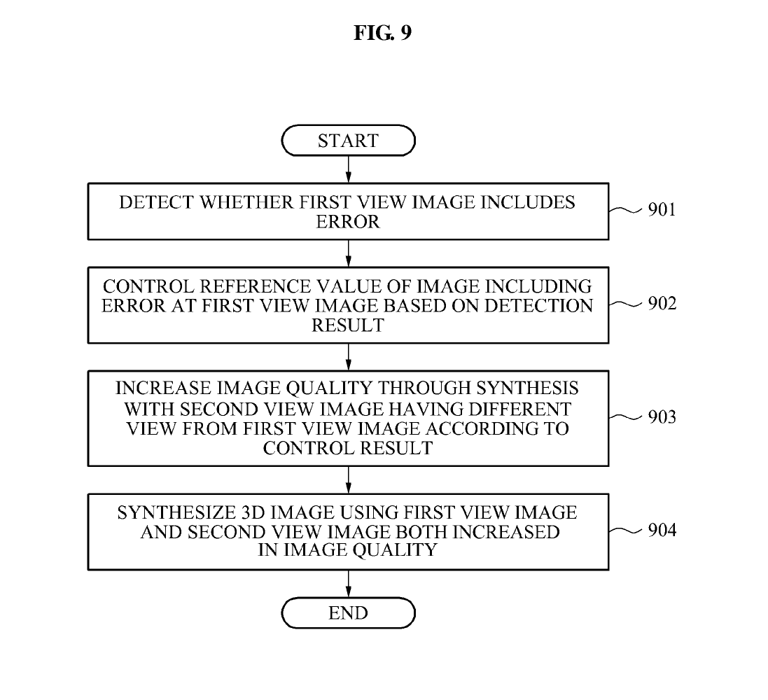

FIG. 9 is a flowchart illustrating an image quality increasing method according to still another embodiment of the present invention.

In operation 901, an image quality increasing apparatus may detect whether an image of a first view, which is a random view among views provided by a multi view 3DTV, includes an error.

In operation 902, the image quality increasing apparatus may synthesize with a second view image having a different view from the first view image, by controlling a weight value of reference information of an image in which the error is generated at the first view image according to the detection result.

In operation 903, the image quality increasing apparatus may increase the image quality based on a result of synthesis.

In operation 904, the image quality increasing apparatus may synthesize a 3D image using the quality increased first view image and the second view image.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An image quality increasing apparatus comprising:
an error detection unit to detect whether a reference image includes an error;
a reference information correction unit to correct reference information for increasing an image quality of an additional image based on a detection result;
an image quality increasing unit to increase the image quality of the additional image corresponding to the reference information; and
a three-dimensional (3D) image synthesis unit to synthesize a 3D image using the quality increased additional image and the reference image.

2. The image quality increasing apparatus of claim 1, wherein the error detection unit detects presence of the error by extracting a block or a frame in which a transmission error is generated from the reference image received in units of block or frame.

3. The image quality increasing apparatus of claim 2, wherein the error detection unit detects presence of the error in units of frame according to whether a loss is generated in data in units of the frame separated by demultiplexing (DEMUX).

4. The image quality increasing apparatus of claim 2, wherein the error detection unit detects presence of the error in units of block through a loss of stream data or by inspecting decoded data in units of the block.

5. The image quality increasing apparatus of claim 2, wherein the error detection unit detects presence of the error in units of block by checking continuity of a decoded image with respect to a previous frame and continuity of values of block units in units of macro blocks.

6. The image quality increasing apparatus of claim 1, wherein the reference information correction unit determines a weight value of the reference information to be different based on the detection result.

7. The image quality increasing apparatus of claim 1, wherein the reference information comprises at least one of a depth map, a disparity map, a conditional depth map, an interview vector, and quality increasing reference information.

8. The image quality increasing apparatus of claim 1, wherein the reference information correction unit corrects a weight value of the reference image with respect to all blocks of a frame when the error is generated in units of frame, and corrects the weight value of the reference image with respect to a block in which the error is generated when the error is generated in units of blocks.

9. The image quality increasing apparatus of claim 1, wherein the reference information correction unit corrects a weight value of the reference image to approximate to zero with respect to a block including the error, and corrects the weight value of the reference image to approximate to one with respect to a block not including the error.

10. An image quality increasing apparatus comprising:
a reference image detection unit to detect whether a reference image includes an error;
an additional image detection unit to detect whether an additional image includes an error;
a reference information correction unit to correct reference information for increasing an image quality of the reference image and the additional image based on a detection result with respect to the reference image and a detection result with respect to the additional image;
an image quality increasing unit to increase the image quality of the reference image and the additional image corresponding to the reference information; and
a three-dimensional (3D) image synthesis unit to synthesize a 3D image using the additional image and the reference image which are increased in the image quality.

11. The image quality increasing apparatus of claim 10, wherein the receive image error detection unit and the additional image error detection unit detect presence of the error by extracting a block and a frame in which a transmission error is generated from the reference image received in units of block or frame.

12. The image quality increasing apparatus of claim 10, wherein the receive image error detection unit and the additional image error detection unit detect presence of the error in units of frame according to whether a loss is generated in data in units of the frame separated by demultiplexing (DEMUX).

13. The image quality increasing apparatus of claim 10, wherein the receive image error detection unit and the additional image error detection unit detect presence of the error in units of block through a loss of stream data or by inspecting decoded data in units of the block.

14. The image quality increasing apparatus of claim 10, wherein the receive image error detection unit and the additional image error detection unit detect presence of the error in units of block by checking continuity of a decoded image with respect to a previous frame and continuity of values of block units in units of macro blocks.

15. The image quality increasing apparatus of claim 10, the reference information correction unit corrects a weight value of the reference image corresponding to the detection result with respect to the reference image and corrects a weight value of the additional image corresponding to the detection result with respect to the additional image, with respect to reference information including a linear combination of the weight value of the reference image and the weight value of the additional image.

16. An image quality increasing apparatus comprising:
an error detection unit to detect whether a first view image includes an error;
an image synthesis unit to synthesize with a second view image having a different view from the first view image by controlling a weight value of reference information of an image in which the error is generated at the first view image according to a detection result;
an image quality increasing unit to increase an image quality of the image based on a synthesis result; and
a three-dimensional (3D) image synthesis unit to synthesize a 3D image using the first view image and the second view image which are increased in the image quality.

17. The image quality increasing apparatus of claim 16, wherein the error detection unit detects presence of the error by extracting a block and a frame in which a transmission error is generated from the first view image received in units of block or frame.

18. An image quality increasing method comprising:
detecting whether a reference image includes an error;
correcting reference information for increasing an image quality of an additional image based on a detection result;
increasing the image quality of the additional image corresponding to the reference information; and
synthesizing a three-dimensional (3D) image using the quality increased additional image and the reference image.

19. An image quality increasing method comprising:
detecting whether a reference image includes an error;
detecting whether an additional image includes an error;
correcting reference information for increasing an image quality of the reference image and the additional image based on a detection result with respect to the reference image and a detection result with respect to the additional image;
increasing the image quality of the reference image and the additional image corresponding to the reference information; and
synthesizing a three-dimensional (3D) image using the additional image and the reference image which are increased in the image quality.

20. An image quality increasing method comprising:
detecting whether a first view image includes an error;
controlling a weight value an image in which the error is generated at the first view image based on a detection result;
increasing an image quality of the image by synthesizing with a second view image having a different view from the first view image according to a control result; and
synthesizing a three-dimensional (3D) image using the first view image and the second view image which are increased in the image quality.
